(19) United States
(12) Patent Application Publication
(10) Pub. No.: US 2010/0318384 A1
(43) Pub. Date: Dec. 16, 2010

(54) METHOD OF PURCHASING A TICKET FOR A JOURNEY ON TRANSPORTATION MEANS

(75) Inventor: Torbernt Hjelmvik, Jarfalla (SE)

Correspondence Address: YOUNG & THOMPSON, 209 Madison Street, Suite 500, Alexandria, VA, 22314, US

(73) Assignee: MODUL-SYSTEM SWEDEN AB, Jarfalla (SE)

(21) Appl. No.: 12/377,749

(22) PCT Filed: Jul. 30, 2007
(86) PCT No.: PCT/SE07/50537

§ 371 Date: Feb. 17, 2009

(30) Foreign Application Priority Data
Aug. 18, 2006 (SE) 0601702-4

(51) Int. Cl. G06Q 10/00; G06Q 30/00

(52) U.S. Cl. 705/5

(57) ABSTRACT

A method of purchasing, paying for and validating a journey wherein the traveler books the journey via a mobile telephone, on the Internet or at a booking terminal of a travel agency. The method includes starting in a superordinate data system including a database an account K that can be billed and a number A. The parameters K and A are stored in the database. An identification unit including an identification number R is transferred to the traveler and is stored in the database coupled to the parameters K and A. The traveller purchases a journey L by connecting his phone to the data system, in which L is stored in the database coupled to the stored identification number R. A validation unit reads the identification number R. A check is carried out in a database to ascertain that a journey L tied to the identification number R has been purchased. A signalling device indicates whether or not a journey L has been bought.

The present invention relates to a method of booking and paying for a journey.

In the case of local journeys, there is normally used a season ticket purchased by the traveller. The use of a season ticket necessitates the traveller to visit a ticket sales location each time a season ticket shall be purchased, normally meaning once a month. A journey is validated by the traveller showing the season ticket visually or by passing it through a mechanical reader.

However, a serious problem arises with respect to buses, despite the occurrence of season tickets and advanced bookings, due to the fact that many people pay for their ticket in cash. As a result, the payment procedure is slow. Moreover, cash payments increase the risk of robbery.

In the case of journeys by train and by air, tickets are booked and paid in travel agents for instance prior to the journey taking place, and in the majority of cases a physical ticket is issued prior to the journey. In total, this procedure is time consuming and therewith expensive. The journey is validated by showing the ticket to a controlling official.

In present times an increasing number of travellers book their journeys themselves on the internet, with regard to journeys by train and by air. In such cases there is issued a booking number and there can be printed or written out a paper slip on which the booking number and the journey are noted. The journey is paid for in conjunction with the booking, by sending the number of an account card in connection with the internet. The printed paper slip is valid as a ticket for the journey noted.

The present invention greatly simplifies the payment for and the validation of a journey.

The present invention thus relates to a method for the purchase, payment and validation of a journey by means of transportation means, wherein the traveller books the trip or trips via a mobile phone, on the internet or at a booking office or the like belonging to a travel agent and is characterized in that in a first step a chargeable account K and a number, an A-number such as a mobile phone number or a telephone number of a land telephone network, or an IP address or the like, named A is stored in a superordinate computer system including a database, wherein the parameters K and A are stored in said database; wherein an identifying unit comprising an identifying number R is given to the traveller wherein the parameter R is stored in the said database coupled or tied to the parameters K and A; wherein the traveler purchases a journey L in a second step via his/her mobile phone, on the Internet or at a booking office or the like, by connecting to the data system where L is stored in said database coupled to the stored identification number R; wherein in a third step a validation unit which includes a mechanical reader provided in or in the near vicinity of the means of transportation is caused to read the identification number R of the identifying unit, and wherein in a fourth step there is carried out in a database or in connection with the means of transportation a check that a journey L tied to the identification number R has been bought, wherewith database information has been transferred to said database from the database of the superordinate data system; and wherein in a fifth step a signalling means arranged in or in connection with the means of transportation is caused to indicate whether or not a journey L has been purchased; and wherein the second, third, fourth and fifth steps of the method are repeated in respect of further journeys.

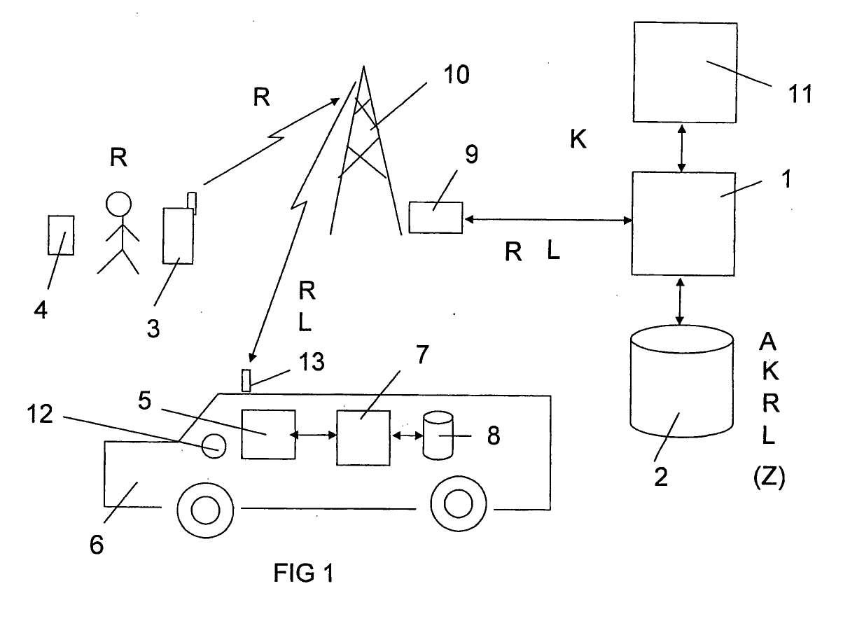

The invention will now be described in more detail partly with reference to an embodiment of the invention illustrated by way of example in the accompanying drawing, where FIG. 1 is a block diagram which illustrates the invention.

The present invention thus relates to a method of booking, paying for, and validating a journey by transportation means, wherein the traveler books the journey or journeys via mobile phone on the Internet, or at a booking terminal or corresponding travel agent. By validation of a journey is meant a mechanical or manual check that the ticket applies to the intended journey.

According to the invention in a first step a chargeable account K and a number, a A-number such as a mobile phone number or a telephone number belonging to a land telephone network, or an IP address or the like, designated A, is caused to be stored in a superordinate data system 1 that includes a database 2. The number A or the address belongs to the traveller. The chargeable account K may be the number of a credit card or the like, such as an autogiro permit, a bank account, or permission to bill the customer or the like. The parameters K and A are stored in the database 2. The superordinate data system 1 will conveniently belong to the traffic operator, for instance a local traffic company, a railroad company or an aircraft company. This first step is not repeated until the data K or A have been changed.

The first step also includes the transfer of an identification unit comprising a traveller identification number R, and causing the parameter R to be stored in said database coupled to the parameters K and A.

According to a preferred embodiment of the invention, the identification unit is the mobile phone 3 and the identification number R coincides with the telephone number A of the cell phone. By transfer of the identification to the traveler is meant in this case that the superordinate data system 1 activates the number R in the system and stores it in the database 2 coupled to the parameters K and A.

According to an alternative embodiment, the identification means is a transponder 4 in which the identification number is stored in a memory belonging to said transponder. The transponder 4 is transferred to the traveler, e.g. by post. To this end, the traveler may state his/her post address Z when carrying out the first step.

In a second step the traveller purchases a journey L via his/her mobile phone 3, on the Internet, or at a booking office or the like by coupling the mobile phone to the said data system 1, wherewith L is stored in the said database 2 coupled to the stored identification number R.

In a third step a validating unit 5 in the form of a mechanical reader provided in or in the close vicinity of the transportation means 6 is caused to be adapted to read the identification number R of the identification unit 3; 4. The validation unit is provided in the transportation means 6. The validation unit 5 thus reads the ticket.

When the identification unit is a transponder 4, the validation unit 5 includes a reader in the form of a known communicator which reads the memory of the transponder 4 in response to a query signal, by virtue of the transponder modulating the query signal with the identification number R. The transponder must thus be a so-called passive RFID transponder or an active RFID transponder. The communicator is included in the validation unit 5.

Instead of a transponder, the identification unit may be a machine readable card that includes a bar-code which constitutes the identification number R.

When the identification unit is a mobile telephone 3 and the identification number R coincides with the number A of the mobile phone, the traveller is able to call a special telephone number which is received by a computer system 7 in or in the vicinity of the transportation means 6.

In a fourth step there is activated a control procedure to ascertain that the journey L tied to the identification number R has been purchased. The control takes place in coaction with a database 8 or in connection with the transportation means 6, or, alternatively, directly in coaction with the superordinate data system 1.

Information as to which journey has been bought is first registered in the superordinate data system 1. The superordinate data system 1 transfers information relating to purchased journeys at suitable time intervals, via a telephone network 9 and, when necessary, via a mobile telephone network 10 or the like to the data system 7 in or in the close vicinity of the transportation means 6. The parameters R and L are herewith transferred. If data is also to be transferred to a data system 5 on the transportation means 6, the transportation means will be equipped with a transceiver unit 13.

The network may be a WLAN or WIMAX network instead of a mobile phone network according to 3G or 4G.

In conjunction with the purchase of a journey, the superordinate data system 1 sends information to the company 11 that manages the account K given by the traveler, which is therewith billed.

In a fifth step a signalling device 12 provided in or in the close vicinity of the transportation means is caused to indicate whether or not a journey L has been purchased. The signalling device may be a lamp or an accoustic device or a display.

The second, third, fourth and fifth steps are repeated for further journeys.

By the phrase “in or in the close proximity of the transportation means” is meant that in the case of a bus for instance, the devices are arranged in the transportation means, whereas when the transportation means is an underground train or subway, the devices are provided at the subway barriers, i.e. the subway entrances.

According to one preferred embodiment of the invention, the identification number R is stored together with an identification of the journey L in a database 8 or in or in the close proximity of the transportation means for later control in the database 2 of the superordinate data system 1 in those cases when the said transceiver device can not be connected to the said database for receiving information as to whether or not purchased journeys are tied to different identification numbers R.

However, such registration will only take place when the identification number R is present in the database 8. The fact that the identification number R is found in the database indicates that the number is not blocked. When the database 8 is updated with purchased journeys L and identification numbers R, the database 8 can also be updated with all non-blocked identification numbers R with regard to transportation systems.

When applying the inventive method, the traveller purchases a journey which is validated in a simple manner in or in connection with the transportation means. The method enables a person to purchase one or more tickets at one and the same time. For instance, tickets for journeys to and from work can be purchased to cover any desired period of time. The method also enables all administration and the distribution of tickets and season marks to be eliminated.

The present invention thus affords a remarkable simplification.

Although the invention has been described above with reference to a number of exemplifying embodiments, it will be understood that, for instance, the identification device can be given another corresponding design. Moreover, several parameters or pieces of data other than the parameters L and R can be stored in the database in or in the close vicinity of the transportation means.

The present invention shall not therefore be considered as being limited to the exemplifying embodiments described above, since variations can be made within the scope of the accompanying claims.

1. A method of purchasing a ticket for a journey on a transportation means, paying for the journey and validating the journey on said transportation means, wherein the method comprises the steps in which the traveler books the journey or journeys via a mobile phone, on the Internet or at a booking terminal or the like belonging to a travel agent, characterized by a first method step in which an account K that can be billed and a number, an A-number, such as a mobile phone number or a telephone number of a land based telephone network, or an IP address or its like, designated A are stored in a superordinate data system (1) that includes a database (2); wherein the parameters K and A are stored in said database (2); wherein an identification unit (3; 4) that includes an identification number R is transferred to the traveler; wherein the parameter R is caused to be stored in said database (2) coupled to the parameters K and A; wherein in a second method step the traveler purchases a journey L via his/her mobile phone on the Internet or at a booking terminal or its like by virtue of the traveller connecting his/her phone to the data system (1) in which L is stored in said database (2) coupled to the stored identification number R; wherein in a third step a validation unit (5) that includes a mechanical reader provided in or in the close proximity of the transportation means (6) is caused to read the identification number R of the identification unit (3;4); wherein in a fourth step there is carried out in a database (8) provided in or in the close proximity of the transportation means (6) a check to ascertain that a journey L tied to the identification number R has been purchased, wherein information has been transferred from the database (2) of the superordinate data system (1) to the database (8); and wherein in a fifth step a signalling device (12) provided in or in the close vicinity of the transportation means (6) is adapted to indicate whether or not a journey L has been bought; and wherein the second, third, fourth and fifth steps are repeated in respect of additional journeys.

2. A method according to claim 1, characterized by coupling a transceiver device (13) provided in or in the close proximity of the transportation means (6) to the database (2) of the superordinate system (1) on certain occasions; and wherein identification numbers R for journeys L that have been purchased and that concern the transportation means in question are caused to be transferred to said database (8) provided in or in the close proximity of the transportation means (6).

3. A method according to claim 1, characterized by causing the identification number to coincide with said number A.

4. A method according to claim 1, characterized in that the identification device used is a transponder (4) which is caused to be read with regard to the identification number R of said validating device (5).

5. A method according to claim 1, characterized in that the identification device used is a mobile telephone (3); wherein the telephone number A of the mobile telephone is caused to be the identification number R; and
in that the mobile telephone number A is caused to be transferred to said validating device (5).

6. A method according to claim 1, characterizeed in that when the said transceiver device (13) can not be successively coupled to the database (2) of the superordinate data system (1) in order to receive information relating to purchased journeys L tied to different identification numbers R, the identification number R together with an identification of the journey L is caused to be stored in the said database (8) provided in or in the close proximity of the transportation means (6) for later control against the database (2) of the superordinate data system (1).

7. A method according to claim 2, characterized by causing the identification number to coincide with said number A.

8. A method according to claim 2, characterized in that the identification device used is a transponder (4) which is caused to be read with regard to the identification number R of said validating device (5).

9. (New A method according to claim 3, characterized in that the identification device used is a transponder (4) which is caused to be read with regard to the identification number R of said validating device (5).

10. A method according to claim 2, characterized in that the identification device used is a mobile telephone (3);
wherein the telephone number A of the mobile telephone is caused to be the identification number R; and in that the mobile telephone number A is caused to be transferred to said validating device (5).

11. A method according to claim 3 characterized in that the identification device used is a mobile telephone (3);
wherein the telephone number A of the mobile telephone is caused to be the identification number R; and in that the mobile telephone number A is caused to be transferred to said validating device (5).

12. A method according to claim 2, characterizeed in that when the said transceiver device (13) can not be successively coupled to the database (2) of the superordinate data system (1) in order to receive information relating to purchased journeys L tied to different identification numbers R, the identification number R together with an identification of the journey L is caused to be stored in the said database (8) provided in or in the close proximity of the transportation means (6) for later control against the database (2) of the superordinate data system (1).

13. A method according to claim 3, characterizeed in that when the said transceiver device (13) can not be successively coupled to the database (2) of the superordinate data system (1) in order to receive information relating to purchased journeys L tied to different identification numbers R, the identification number R together with an identification of the journey L is caused to be stored in the said database (8) provided in or in the close proximity of the transportation means (6) for later control against the database (2) of the superordinate data system (1).

14. A method according to claim 4, characterizeed in that when the said transceiver device (13) can not be successively coupled to the database (2) of the superordinate data system (1) in order to receive information relating to purchased journeys L tied to different identification numbers R, the identification number R together with an identification of the journey L is caused to be stored in the said database (8) provided in or in the close proximity of the transportation means (6) for later control against the database (2) of the superordinate data system (1).

15. A method according to claim 5, characterizeed in that when the said transceiver device (13) can not be successively coupled to the database (2) of the superordinate data system (1) in order to receive information relating to purchased journeys L tied to different identification numbers R, the identification number R together with an identification of the journey L is caused to be stored in the said database (8) provided in or in the close proximity of the transportation means (6) for later control against the database (2) of the superordinate data system (1).
